(19) United States
(12) Patent Application Publication
(10) Pub. No.: US 2024/0241550 A1
(43) Pub. Date: Jul. 18, 2024

(54) DISPLAY MODULE, DISPLAY DEVICE, AND PREPARATION METHOD OF DISPLAY DEVICE

(71) Applicant: Xiamen Tianma Display Technology Co., Ltd., Xiamen (CN)

(72) Inventor: Zhiwei Wang, Xiamen (CN)

(73) Assignee: Xiamen Tianma Display Technology Co., Ltd., Xiamen (CN)

(21) Appl. No.: 18/621,382

(22) Filed: Mar. 29, 2024

(30) Foreign Application Priority Data
Dec. 18, 2023 (CN) 202311745078.1

(51) Int. Cl. G06F 1/16

(52) U.S. Cl. CPC G06F 1/1656; G06F 1/1652

(57) ABSTRACT

Provided are a display module, a display device, and a preparation method of a display device. The display module includes a display panel, a support module and a sealing glue. The display panel includes a display portion, and the display portion is provided with a light-emitting structure. A cover plate is arranged at a side of the display portion in a thickness direction, and the support module is arranged at a side of the display portion away from the cover plate. In a direction parallel to a plane where the cover plate is located, the support module and the cover plate are arranged beyond the display panel, to form a slot-shaped structure, and the sealing glue is at least partially located within the slot-shaped structure.

### CROSS-REFERENCE TO RELATED APPLICATION(S)

This application claims priority to Chinese patent application Ser. No. 202311745078.1 filed with the China National Intellectual Property Administration (CNIPA) on Dec. 18, 2023, the disclosure of which is incorporated herein by reference in its entirety.

### TECHNICAL FIELD

The present application relates to the field of display equipment technologies, and in particular, a display module, a display device, and a preparation method of a display device.

### BACKGROUND

With the development of display technology, display devices (for example, a mobile phone, a tablet, a wearable band or a television) are widely used. In addition, the requirements of users on display devices are gradually improved, and the display devices gradually develop in trends of being thinner, lighter and full screen. However, this also causes the preparations corresponding to the display devices to have an increased difficulty, and the requirement for the preparation techniques to be higher.

### SUMMARY

A display module, a display device, and a preparation method of a display device are provided according to embodiments of the present application, which can improve yield of the display device.

A display module is provided according to an embodiment of the present application. The display module includes a display panel, a cover plate, a support module and a sealing glue. The display panel includes a display portion, and the display portion is provided with a light-emitting structure. The cover plate is arranged at a side of the display portion in the thickness direction of the display portion. The support module is arranged at a side of the display portion facing away from the cover plate. In a direction parallel to a plane where the cover plate is located, the support module and the cover plate are arranged beyond the display panel to form a slot-shaped structure, and the sealing glue is at least partially located within the slot-shaped structure.

A display device is provided according to an embodiment of the present application. The display device includes the display panel, the cover plate, the sealing glue and at least part of the structures of the support module in the display module according to any one of the above embodiments.

A preparation method of a display device is provided according to an embodiment of the present application, and the method includes the following.

A display panel is arranged to fit against a cover plate. The display panel includes a display portion, the display portion is provided with a light-emitting structure, and the cover plate is arranged at a side of the display portion in the thickness direction.

A support module is formed at a side of the display portion facing away from the cover plate, and in a direction parallel to a plane where the cover plate is located, the support module and the cover plate are arranged beyond the display panel to form a slot-shaped structure.

A sealing glue is formed in the slot-shaped structure.

### BRIEF DESCRIPTION OF DRAWINGS

To illustrate technical schemes in embodiments of the present disclosure more clearly, drawings used in description of the embodiments are briefly described hereinafter. For the person of ordinary skill in the art, other drawings can be obtained based on these drawings without making creative efforts.

FIG. 1 is a schematic structural diagram illustrating the relative positions between a display panel, a support layer and a cover plate in a display module according to an embodiment of the present application.

FIG. 2 is a sectional view of FIG. 1 at A-A.

FIG. 3 is a schematic structural diagram illustrating relative positions between a display panel, a first sacrificial layer and a cover plate in another display module according to an embodiment of the present application.

FIG. 4 is a sectional view of FIG. 3 at B-B.

FIG. 5 is a sectional view of FIG. 3 at C-C.

FIG. 6 is a schematic structural diagram illustrating relative positions between a display panel, a second sacrificial layer and a cover plate in another display module according to an embodiment of the present application.

FIG. 7 is a sectional view of another display module at B-B according to an embodiment of the present application.

FIG. 8 is a schematic structural diagram illustrating relative positions between a display panel, a first sacrificial layer and a cover plate in another display module according to an embodiment of the present application.

FIG. 9 is a sectional view of FIG. 8 at D-D.

FIG. 10 is a sectional view of another display module according to an embodiment of the present application.

FIG. 11 is a sectional view of another display module according to an embodiment of the present application.

FIG. 12 is a schematic structural diagram illustrating relative positions between a display panel, a first sacrificial layer and a cover plate in another display module according to an embodiment of the present application.

FIG. 13 is a sectional view of a display device according to an embodiment of the present application.

FIG. 14 is a flow chart of a preparation process of a display device according to an embodiment of the present application.

FIG. 15A to FIG. 15C are schematic structural diagrams illustrating a preparation process of a display device according to an embodiment of the present application.

FIG. 16 is a flow chart of another preparation process of a display device according to an embodiment of the present application.

FIG. 17A to FIG. 17C are schematic structural diagrams illustrating another preparation process of a display device according to an embodiment of the present application.

FIG. 18 is a flow chart of another preparation process of a display device according to an embodiment of the present application.

FIG. 19A to FIG. 19C are schematic structural diagrams illustrating another preparation process of a display device according to an embodiment of the present application.

FIG. 20 is a flow chart of another preparation process of a display device according to an embodiment of the present application.

FIG. 21 is a schematic structural diagram illustrating another preparation process of a display device according to an embodiment of the present application.

### DETAILED DESCRIPTION

The features and exemplary embodiments of various aspects of the present application are described in detail hereinafter. In order to make the object, technical solutions and advantages of the present application clearer, the present application is described in further detail hereinafter with reference to the drawings and embodiments. It is to be understood that the embodiments described here are only intended to explain the present application, rather than limiting the present application. It will be apparent to a person skilled in the art that the present application may be implemented without some of these specific details. The following description of embodiments is merely intended to provide a better understanding of the present application by illustrating examples thereof.

It is to be noted that in this application, relational terms such as first and second are only used to distinguish one entity or operation from another entity or operation, and do not necessarily require or imply that there is any such actual relationship or sequence between these entities or operations. Furthermore, the terms “comprise”, “include” or any other variation thereof are intended to cover a non-exclusive inclusion such that a process, method, article, or apparatus that includes a list of elements includes not only those elements, but also those not expressly listed other elements, or elements inherent to the process, method, article or apparatus. Without further limitation, an element defined by the statement “comprising . . . ” does not exclude the presence of additional identical elements in a process, method, article, or apparatus that includes the stated element.

With the development of science and technology, display devices have also gradually developed, and full-screen display devices have emerged. Under the demand for the full-screen display, the frame size of the display device is required to be reduced. After the frame size is reduced, the overall protective performance of the display device may be decreased. However, to meet the demand of practical use, the display device is required to have properties such as sufficiently high sweat stain resistance and grease resistance.

On this basis, in the related art, glue may be coated around the four sides of the display module to prevent sweat stains, grease, etc. from entering the interior of the module, to improve the reliability of the subsequently formed display device in usage. However, limited by factors such as process accuracy, the sealing glue for side sealing all around the display module has issues such as poor coating accuracy, large fluctuations, an accompanied glue overflow and an accompanied glue shortage.

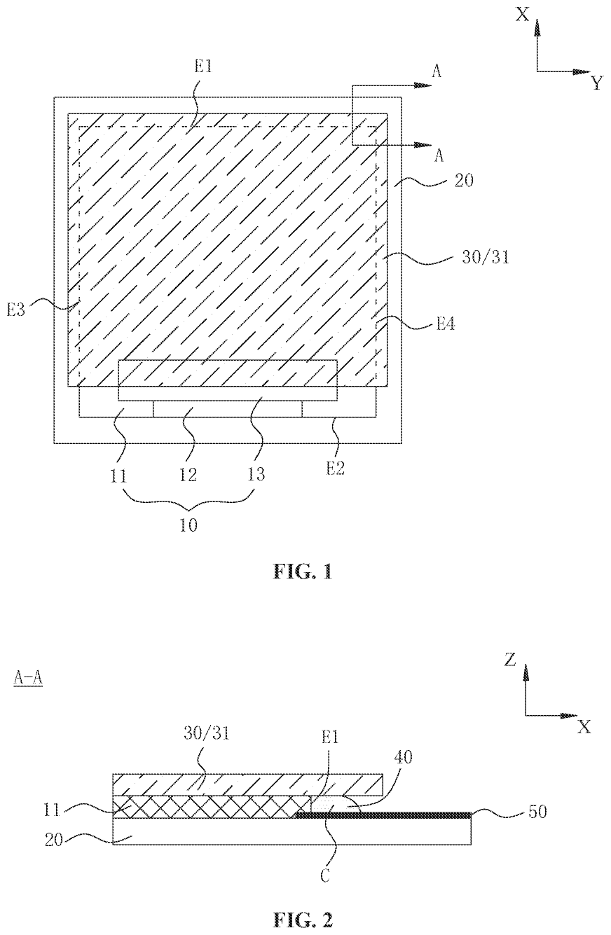

In view of this, in a first aspect, reference may be made to FIG. 1 and FIG. 2. A display module is provided according to an embodiment of the present application. The display module includes a display panel 10, a support module 30 and a sealing glue 40. The display panel 10 includes a display portion 11, and the display portion 11 is provided with a light-emitting structure (not shown in the drawing). The cover plate 20 is arranged at a side of the display portion 11 in a thickness direction Z, and the support module 30 is arranged at a side of the display portion 11 facing away from the cover plate 20. In a direction parallel to a plane where the cover plate 20 is located, the support module 30 and the cover plate 20 are arranged beyond the display panel 10 to form a slot-shaped structure C, and the sealing glue 40 is at least partially located within the slot-shaped structure C.

The display module is configured to subsequently form a display device. Depending on different practical requirements, the display device may include all structures in the display module, or the display device may include only part of the structures in the display module, that is, in the process of preparing and forming the display device, part of the film layer structures in the display module may be selectively removed.

The display portion 11 is a functional component for implementing a display effect in the display panel 10. The display portion 11 generally includes a variety of different film layers arranged in a stacked manner. For example, the display portion 11 includes an array layer, a light-emitting layer, and an optical adhesive layer, and other layers that are arranged in a stacked manner, and the light-emitting structure may be arranged in the light-emitting layer. In addition to the display portion 11, the display panel 10 may further be provided with other structures depending on requirements. The structures for the display panel 10 are not limited in the embodiments of the present application.

The cover plate 20 is arranged at the side of the display portion 11 in the thickness direction Z. For example, the cover plate 20 may be arranged at a light-emitting side of the display portion 11 and fit against the display portion 11. The cover plate 20 may protect the display panel 10. In the direction parallel to the plane where the cover plate 20 is located, the cover plate 20 is arranged partially beyond the display panel 10. In an embodiment, an outer contour of the orthographic projection of the display panel 10 on the cover plate 20 may be located within an outer contour of the cover plate 20. Further, an ink layer 50 may be provided at a position where the cover plate 20 is beyond the display panel 10. The ink layer 50 has a certain light-shielding effect to facilitate the reduction in reflection issues corresponding to the subsequently formed display device, thus improving the display effect.

The support module 30 is arranged at the side of the display portion 11 facing away from the cover plate 20, that is, the support module 30 and the cover plate 20 are arranged at different sides of the display portion 11, the cover plate 20 is arranged at the light-emitting side of the display portion 11, and the support module 30 is arranged at a backlight side of the display portion 11. The support module 30 may be arranged to fit against the display panel 10. The display panel 10 may further include other structures in addition to the display portion 11; therefore, depending on different practical requirements, the support module 30 may be arranged to at least partially fit against the display portion 11, or the support module 30 may also be arranged to at least partially fit against other structures in the display panel 10.

The composition of film layers inside the support module 30 is not limited in the embodiments of the present application. For example, the support module 30 may include only one film layer structure, or the support module 30 may include multiple film layer structures stacked in the thickness direction Z. In addition, in the process of preparing and forming the display device, all the film layer structures in the support module 30 may be completely retained, or at least part of the film layer structures in the support module 30 may be selectively removed, which is not limited in the embodiments of the present application.

Similar to the cover plate 20, in the direction parallel to the plane where the cover plate 20 is located, the support module 30 is also required to be arranged beyond the display panel 10 to form the slot-shaped structure C. The slot-shaped structure C is configured to accommodate at least part of the structure of the sealing glue 40. In the related art, there is no slot-shaped structure C in the display module, and the sealing glue 40 may drip on the peripheral edge of the display module through dispensing. Limited by the influence of process accuracy, it is prone to a glue overflow or a glue shortage, which is detrimental to the yield and usage reliability of the subsequently formed display device.

In the embodiments of the present application, since the support module 30 and the cover plate 20 are both arranged beyond the display panel 10 in the direction parallel to the plane where the cover plate 20 is located, the support module 30 and the cover plate 20 may together define and form the slot-shaped structure C. The existence of the slot-shaped structure C may play a certain blocking role for the glue in the process of glue coating so that the formed sealing glue 40 can be limited to the position where the slot-shaped structure C is located. In addition, the sealing glue 40 can be maintained at a certain size and in a certain shape, thereby improving the reliability of the relative position of the sealing glue 40 and reducing the risk of occurrence of issues such as a glue overflow or a glue shortage, and further facilitating improvement of the yield of the display device and improvement of the reliability of the display device in blocking sweat stain, grease, etc.

It is to be noted that the display panel 10 may further include other structures in addition to the display portion 11; therefore, to form the slot-shaped structure C, the support module 30 and the cover plate 20 are both required to be arranged beyond the display panel 10, rather than just beyond the display portion 11. The positional relationship between the display panel 10, the support module 30 and the cover plate 20 is not limited in the embodiments of the present application, as long as the part of structures of the support module 30 and the cover plate 20 beyond the display panel 10 may together define the slot-shaped structure C.

In some embodiments, as shown in FIG. 1 and FIG. 2, the support module 30 includes a support layer 31 arranged to fit against the display portion 11, and in the direction parallel to the plane where the cover plate 20 is located, the support layer 31 is arranged beyond the display portion 11 to form the slot-shaped structure C.

The support layer 31 is in close contact with the display portion 11. The support layer 31 may support and bear the display portion 11 to reduce the risk of excessive deformation of the display portion 11 during subsequent use. In an embodiment, the support layer 31 may include a metal material. For example, the support layer 31 may include a structure with greater structural strength, such as a steel sheet.

In the related art, the orthographic projection of the support layer 31 on the cover plate 20 is generally located within the orthographic projection of the display portion 11 on the cover plate 20, that is, in the direction parallel to the plane where the cover plate 20 is located, the support layer 31 cannot be arranged beyond the display portion 11. In the embodiments of the present application, the size and shape of the support layer 31 are adjusted so that in the direction parallel to the plane where the cover plate 20 is located, the support layer 31 may be arranged beyond the display portion 11, and thus the support layer 31 together with the cover plate 20 define the slot-shaped structure C.

This design may form the slot-shaped structure C in the display module without additionally adding other film layer structures, thereby improving the reliability of the relative position of the sealing glue 40 and reducing the risk of occurrence of a glue overflow or a glue shortage, so the design has a simple structure and strong practicality.

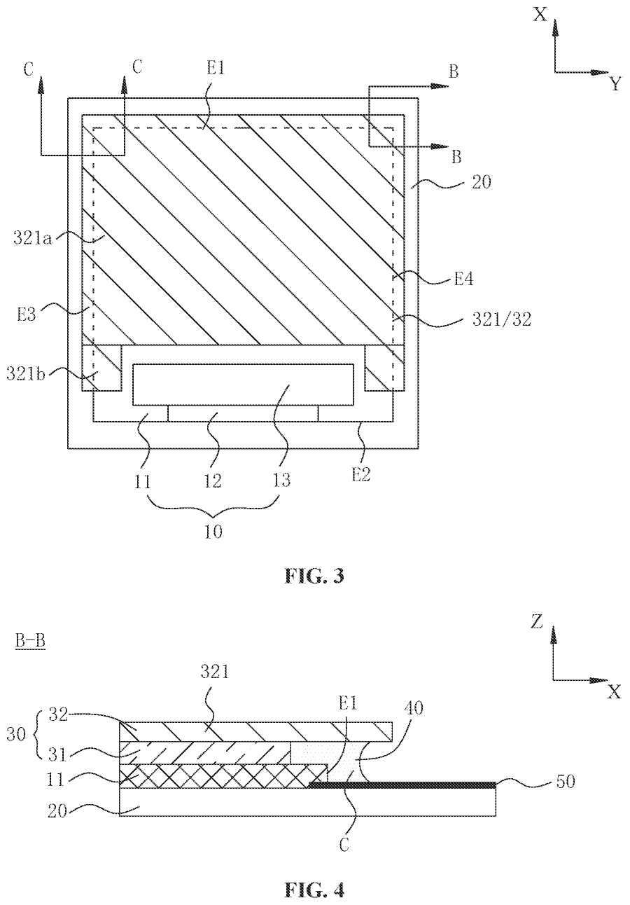

In some embodiments, referring to FIG. 3 and FIG. 4, the support module 30 includes a support layer 31 arranged to fit against the display portion 11 and a first sacrificial layer 32 at a side of the support layer 31 facing away from the display portion 11, and the orthographic projection of the display portion 11 on the cover plate 20 covers the orthographic projection of the support layer 31 on the cover plate 20. In an embodiment, the first sacrificial layer 32 is arranged beyond the display panel 10 in the direction parallel to the plane where the cover plate 20 is located.

The support module 30 includes at least two structural parts, namely, the support layer 31 and the first sacrificial layer 32. The support layer 31 is sandwiched between the first sacrificial layer 32 and the display portion 11. The support layer 31 is arranged to fit against the display portion 11, and the first sacrificial layer 32 and the display portion 11 are arranged to be spaced apart in the thickness direction Z. Further, the first sacrificial layer 32 may be arranged to fit against the support layer 31, or the first sacrificial layer 32 may also be spaced apart from the support layer 31 in the thickness direction Z, as long as the first sacrificial layer 32 is located at the side of the support layer 31 facing away from the display portion 11.

The orthographic projection of the display portion 11 on the cover plate 20 covers the orthographic projection of the support layer 31 on the cover plate 20, that is, in the direction parallel to the plane where the cover plate 20 is located, the support layer 31 is arranged not beyond the display portion 11. In this embodiment of the present application, the structure of the support layer 31 is not adjusted, but the first sacrificial layer 32 is additionally added at the side of the support layer 31 facing away from the display portion 11. The first sacrificial layer 32 is required to be arranged beyond the display panel 10 to define, together with the cover plate 20, the slot-shaped structure C.

It is to be noted that although the first sacrificial layer 32 is included in the display module, in the process of preparation, after the sealing glue 40 is fixed in shape, the first sacrificial layer 32 may be selectively removed or retained, that is, the finally-formed display device may not include the first sacrificial layer 32. Apparently, in some other embodiments, the finally-formed display device may also include the first sacrificial layer 32, which is not limited in the embodiments of the present application.

In summary, in the embodiments of the present application, by additionally adding the first sacrificial layer 32 into the display module, the slot-shaped structure C may be formed in the display module without adversely affecting other film layer structures. In this manner, the reliability of the relative position of the sealing glue 40 is improved and the risk of occurrence of issues such as a glue overflow or a glue shortage is reduced Further, in the subsequent process of forming the display device, the first sacrificial layer 32 may be selectively removed, the finally-formed display device can be consistent with a conventional display device in terms of structure. Alternatively, the first sacrificial layer 32 may also be selectively retained to improve the supporting effect for the display portion 11, and thus, strong flexibility and practicality are achieved.

It is to be noted that the size of the first sacrificial layer 32 beyond the display panel 10 is not limited in the embodiments of the present application. In an embodiment, the sealing glue 40 has a first preset distance beyond the display panel 10 in the direction parallel to the plane where the cover plate 20 is located, and the size of the first sacrificial layer 32 beyond the display panel 10 is required to be no less than the first preset distance.

In some embodiments, as shown in FIG. 3 and FIG. 4, the display panel 10 includes a bending portion 12 connected to the display portion 11 and a bound portion 13 connected to the bending portion 12, and the bound portion 13 is bent to the side of the display portion 11 facing away from the cover plate 20 by means of the bending portion 12. In the direction parallel to the plane where the cover plate 20 is located, the first sacrificial layer 32 is arranged beyond at least one of the display portion 11 or the bending portion 12.

The display portion 11 is a component for implementing the display effect in the display panel 10. Normally, a side of the display portion 11 facing away from the bound portion 13 is the light-emitting side of the display portion 11, and is configured to display a specific picture, video, etc. for a user.

The bound portion 13 and the display portion 11 are arranged to be spaced apart in the thickness direction Z, and are connected by the bending portion 12. On this basis, it may be seen from the drawings that part of the structure in the support layer 31 is located between the bound portion 13 and the display portion 11, and the first sacrificial layer 32 may be at least partially located at the same height as the bound portion 13 in the thickness direction Z, or the first sacrificial layer 32 may also be at least partially located at a side of the bound portion 13 facing away from the display portion 11.

Further, to define the slot-shaped structure C, the first sacrificial layer 32 is required to be arranged beyond at least one of the display portion 11 or the bending portion 12. With reference to FIG. 3, the display portion 11 may include a first edge E1 and a second edge E2 in a first direction X, and the second edge E2 is connected to the bending portion 12. On this basis, parts of the first sacrificial layer 32 and the cover plate 20 which are located near the first edge E1 are required to be arranged both beyond the display portion 11 to define the slot-shaped structure C. However, parts of the first sacrificial layer 32 and the cover plate 20 which are located near the second edge E2, if being arranged only beyond the display portion 11 but not beyond the bending portion 12, the slot-shaped structure cannot be defined. Therefore, the parts of the first sacrificial layer 32 and the cover plate 20 which are located near the second edge E2, in addition to being beyond the display portion 11, are required to be further beyond the bending portion 12 to define the slot-shaped structure C.

In the embodiments of the present application, depending on different structures at different positions of the display panel 10, the first sacrificial layer 32 is required to be selectively beyond at least one of the display portion 11 or the bending portion 12s to define the slot-shaped structure C together with the cover plate 20, thus improving the reliability of the relative position of the sealing glue 40 and reduce the risk of occurrence of issues such as a glue overflow or a glue shortage.

In some embodiments, reference is made to FIG. 3 to FIG. 5, the display portion 11 includes a first edge E1 and a second edge E2 in the first direction X which are opposite to each other, and a third edge E3 and a fourth edge E4 in the second direction Y which are opposite to each other, the second edge E2 is connected to the bending portion 12, and the first direction X intersects the second direction Y. The first sacrificial layer 32 includes a first sacrificial portion 321, and the first sacrificial portion 321 is arranged beyond at least one of the first edge E1, the third edge E3, or the fourth edge E4.

The first direction X and the second direction Y are both directions parallel to the plane where the cover plate 20 is located. In an embodiment, the first direction X is perpendicular to the second direction Y. Further, the orthographic projection of the display portion 11 on the cover plate 20 being a rectangular structure is taken as an example, the first direction X may be the length direction of the display portion 11, and the second direction Y may be the width direction of the display portion 11.

The display portion 11 has the first edge E1 and second edge E2 opposite to each other in the first direction X, and both the first edge E1 and the second edge E2 may extend in the second direction Y. The display portion 11 has the third edge E3 and fourth edge E4 in the second direction Y opposite to each other, and both the third edge E3 and the fourth edge E4 may extend in the first direction X.

The second edge E2 is connected to the bending portion 12, so the bending portion 12 is arranged beyond the display portion 11 in the first direction X. Therefore, in the first direction X, the two edges of the display panel 10 correspond to the first edge E1 and an edge of the bending portion 12 facing away from the display portion 11 in the first direction X respectively. In the second direction Y, the display portion 11 may generally be arranged beyond the bending portion 12 and the bound portion 13; therefore, the two edges of the display panel 10 in the second direction Y correspond to the third edge E3 and the fourth edge E4 respectively.

On this basis, the first sacrificial layer 32 in the embodiments of the present application includes the first sacrificial portion 321, and in this embodiment of the present application, the first sacrificial portion 321 is further arranged beyond at least one of the first edge E1, the third edge E3 and the fourth edges E4, to enable the first sacrificial portion 321 to be beyond at least one edge of the display panel 10 in the first direction X or the second direction Y. In this manner, the first sacrificial portion 321 is enabled to define the slot-shaped structure C together with the cover plate 20, thereby improving the reliability of the relative position of the sealing glue 40, and reducing the risks of a glue overflow and a glue shortage. Further, in some embodiments, the first sacrificial portion 321 is arranged beyond the first edge E1, the third edge E3 and the fourth edge E4.

In some embodiments, the orthographic projection of the bound portion 13 on the cover plate 20 is located outside the orthographic projection of the first sacrificial portion 321 on the cover plate 20.

The first sacrificial portion 321 may be arranged to directly fit against the support layer 31, or the first sacrificial portion 321 may also be arranged to be spaced apart from the support layer 31. In the thickness direction Z, the first sacrificial portion 321 may also be located at the same height as the bound portion 13. Further, to reduce the structural interference between the first sacrificial portion 321 and the bound portion 13, in the embodiments of the present application, the size and shape of the first sacrificial portion 321 are adjusted so that the orthographic projection of the bound portion 13 on the cover plate 20 is located outside the orthographic projection of the first sacrificial portion 321 on the cover plate 20, thereby reducing the interference of the first sacrificial portion 321 with the bound portion 13 in structure and improving the structural reliability of the display module.

In some embodiments, as shown in FIG. 3 to FIG. 5, the first sacrificial portion 321 includes a first main body portion 321a and a first branch portion 321b located at a side of the first main body portion 321a in the first direction X. The orthographic projection of the first main body portion 321a on the cover plate 20 is located at a side of the orthographic projection of the bound portion 13 on the cover plate 20 in the first direction X, and the orthographic projection of the first branch portion 321b on the cover plate 20 is located at one or more sides of the orthographic projection of the bound portion 13 on the cover plate 20 in the second direction Y.

From the foregoing, it can be seen that to reduce the structural interference between the first sacrificial portion 321 and the bound portion 13, the size and structure of the first sacrificial portion 321 are required to be adjusted. On this basis, the structure of the first sacrificial portion 321 is adjusted in the embodiments of the present application so that the first sacrificial portion 321 includes at least the first main body portion 321a and the first branch portion 321b.

The first main body portion 321a is a main structure in the first sacrificial portion 321. The orthographic projection of the first main body portion 321a on the cover plate 20 is located at a side of the orthographic projection of the bound portion 13 on the cover plate 20 in the first direction X. In an embodiment, the orthographic projection of the first main body portion 321a on the cover plate 20 is located at a side, close to the first edge E1, of the orthographic projection of the bound portion 13 on the cover plate 20. Further, in the direction parallel to the plane where the cover plate 20 is located, the first main body portion 321a may be arranged beyond at least one of the first edge E1, the third edge E3, or the fourth edge E4.

The first branch portion 321b is connected to the first main body portion 321a. The first branch portion 321b and the first main body portion 321a may include the same material, or the first branch portion 321b and the first main body portion 321a may further include different materials. In an embodiment, the first main body portion 321a and the first branch portion 321b are formed into an integral structure.

The orthographic projection of the first branch portion 321b on the cover plate 20 is located at one or more sides of the orthographic projection of the bound portion 13 on the cover plate 20 in the second direction Y. In an embodiment, one or two first branch portions 321b may be provided. When one first branch portion 321b is provided, the orthographic projection of the first branch portion 321b on the cover plate 20 is located at only one side of the orthographic projection of the bound portion 13 on the cover plate 20 in the second direction Y. When two first branch portions 321b are provided, the orthographic projections of the two first branch portions 321b on the cover plate 20 are located at two sides of the orthographic projection of the bound portion 13 on the cover plate 20 in the second direction Y respectively. Further, in the direction parallel to the plane where the cover plate is located, the first branch portion 321b is arranged beyond at least one of the third edge E3 or the fourth edge E4.

In the embodiments of the present application, to reduce the interfere of the first sacrificial portion 321 with the bound portion 13, the size and structure of the first sacrificial portion 321 are adjusted so that the first sacrificial portion 321 includes both the first main body portion 321a and the first branch portion 321b and the orthographic projections of the first main body portion 321a and the first branch portion 321b on the cover plate 20 are located at different sides of the orthographic projection of the bound portion 13 on the cover plate 20 in the first direction X and the second direction Y respectively, thereby reducing the interfere between the first sacrificial portion 321 and the bound portion 13 and improving the reliability of the relative positions and structures between the first sacrificial portion 321 and the bound portion 13.

In some embodiments, in the direction parallel to the plane where the cover plate 20 is located, the first main body portion 321a is arranged beyond the first edge E1, the third edge E3 and the fourth edge E4. Two first branch portions 321b are provided, and the orthographic projections of the two first branch portions 321b on the cover plate 20 are arranged at two sides of the orthographic projection of the bound portion 13 on the cover plate 20 respectively. In the direction parallel to the plane where the cover plate 20 is located, the two first branch portions 321b are arranged beyond the third edge E3 and the fourth edge E4 respectively.

With reference to the above content, it can be seen that the orthographic projection of the first main body portion 321a on the cover plate 20 is located at one side of the orthographic projection of the bound portion 13 on the cover plate 20 in the first direction X, and the orthographic projections of the two first branch portions 321b on the cover plate 20 are located at two sides of the orthographic projection of the bound portion 13 on the cover plate 20 in the second direction Y.

Further, in the embodiments of the present application, the first main body portion 321a is arranged beyond the first edge E1, the third edge E3 and the fourth edge E4 in the direction parallel to the plane where the cover plate 20 is located. In an embodiment, the first main body portion 321a may be arranged beyond the first edge E1 in the first direction X, and the first main body portion 321a may be arranged also beyond the third edge E3 and the fourth edge E4 in the second direction Y.

With this design, at the position of the first edge E1, partial structures of the first main body portion 321a and the cover plate 20 which are beyond the display panel 10 may define and form the slot-shaped structure C to meet the preparation requirements of the sealing glue 40 at the first edge E1. At the partial structural positions of the third edge E3 and the fourth edge E4, partial structures of the first main body portion 321a and the cover plate 20 which are beyond the display panel 10 may also define and form the slot-shaped structure C to meet the preparation requirements of the sealing glue 40 at the partial positions of the third edge E3 and the fourth edge E4. In other words, the existence of the first main body portion 321a can meet the glue coating requirements of the display panel 10 at partial positions of the third edge E3, partial positions of the fourth edge E4, and at least partial positions of the first edge E1.

Moreover, in the direction parallel to the plane where the cover plate 20 is located, the two first branch portions 321b are arranged beyond the third edge E3 and the fourth edge E4 respectively. In an embodiment, the two first branch portions 321b are arranged beyond the third edge E3 and the fourth edge E4 respectively in the second direction Y.

With this design, at the partial structural positions of the third edge E3 and the fourth edge E4, partial structures of the two first branch portions 321b and the cover plate 20 which are beyond the display panel 10 may define and form the slot-shaped structures C to meet the preparation requirements of the sealing glue 40 at the partial positions of the third edge E3 and the fourth edge E4. In other words, the existence of the first branch portions 321b may meet the coating requirements of the display panel 10 at the partial positions of the third edge E3 and the fourth edge E4.

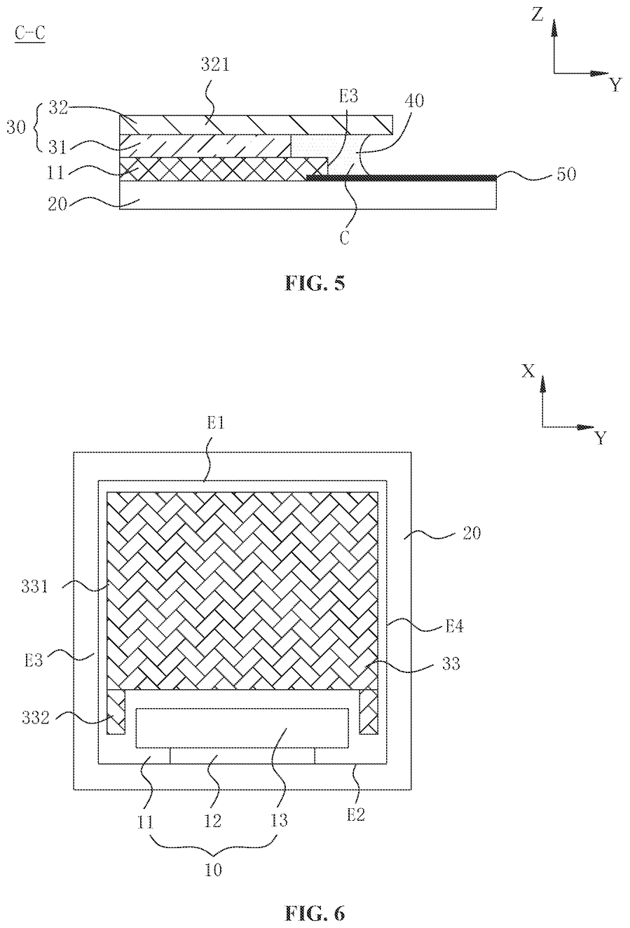

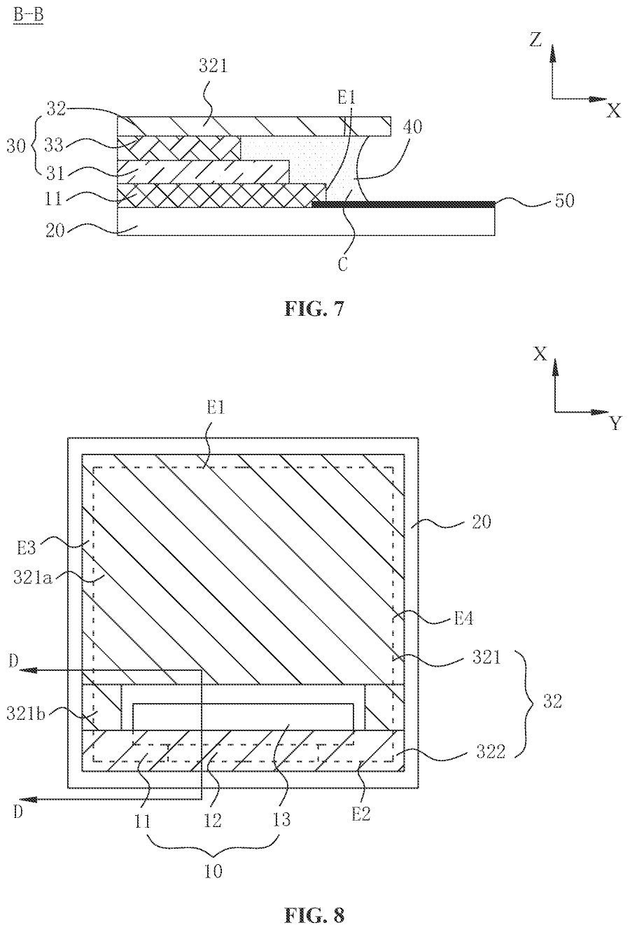

In some embodiments, with reference to FIG. 3, FIG. 6 and FIG. 7, the support module 30 further includes a second sacrificial layer 33 arranged between the first sacrificial portion 321 and the support layer 31, and in the direction parallel to the plane where the cover plate 20 is located, the first sacrificial portion 321 and the support layer 31 are arranged beyond the second sacrificial layer 33.

The second sacrificial layer 33 is arranged to be sandwiched between the first sacrificial portion 321 and the support layer 31. For example, the second sacrificial layer 33 may be arranged to fit against both the first sacrificial layer 32 and the support layer 31. Further, in the direction parallel to the plane where the cover plate 20 is located, the first sacrificial portion 321 and the support layer 31 are both arranged beyond the second sacrificial layer 33, but the support layer 31 may not be arranged beyond the display panel 10, so the second sacrificial layer 33 may not be arranged beyond the display panel 10, that is, the second sacrificial layer 33 does not define the slot-shaped structure C together with the cover plate 20.

In the embodiments of the present application, the support layer 31 is arranged beyond the second sacrificial layer 33 in the direction parallel to the plane where the cover plate 20 is located; therefore, the partial surface of the side of the support layer 31 facing away from the display portion 11 is not covered by the second sacrificial portion 322, and since the support layer 31 and the first sacrificial portion 321 can be spaced apart by the second sacrificial layer 33 in the thickness direction Z, the partial surface of the side of the support layer 31 facing away from the display portion 11 does not fit against the first sacrificial portion 321. In this case, in the process of glue coating, part of the glue may move to the surface of the support layer 31 facing away from the display portion 11 and contact the support layer 31, that is, the support layer 31 may be in contact with the sealing glue 40. In this manner, the reduction in the risk of grease and the like entering into the support layer 31 is facilitated by the sealing glue 40, thereby further improving the reliability of the subsequently formed display device.

The shape of the second sacrificial layer 33 is not limited in the embodiments of the present application. In an embodiment, the outer contour of the orthographic projection of the second sacrificial layer 33 on the cover plate 20 may be the same or similar to the outer contour of the orthographic projection of the first sacrificial portion 321 on the cover plate 20 in terms of shape. Furthermore, the material composition of the second sacrificial layer 33 is not limited in the embodiments of the present application. In an embodiment, the second sacrificial layer 33 and the first sacrificial portion 321 may include the same material.

In some embodiments, as shown in FIG. 6, the orthographic projection of the bound portion 13 on the cover plate 20 is located outside the orthographic projection of the second sacrificial layer 33 on the cover plate 20.

In the embodiments of the present application, similar to the first sacrificial portion 321, to reduce the structural interference between the bound portion 13 and the second sacrificial layer 33, the size and shape of the second sacrificial layer 33 are adjusted in the embodiments of the present application so that the orthographic projection of the bound portion 13 on the cover plate 20 is located outside the orthographic projection of the second sacrificial layer 33 on the cover plate 20, thereby reducing the interfere of the second sacrificial layer 33 with the bound portion 13 in structure, and improving the structural reliability of the display module.

In some embodiments, as shown in FIG. 3, FIG. 6 and FIG. 7, the second sacrificial portion 322 includes a second main body portion 331 and a second branch portion 332 located at a side of the second main body portion 331 in the first direction X. The orthographic projection of the second main body portion 331 on the cover plate 20 is located at a side of the orthographic projection of the bound portion 13 on the cover plate 20 in the first direction X, and the orthographic projection of the second branch portion 332 on the cover plate 20 is located at one or more sides of the orthographic projection of the bound portion 13 on the cover plate 20 in the second direction Y.

From the foregoing, it can be seen that to reduce the structural interference between the second sacrificial layer 33 and the bound portion 13, the size and structure of the second sacrificial layer 33 are required to be adjusted. On this basis, the structure of the second sacrificial layer 33 is adjusted in the embodiments of the present application so that the second sacrificial layer 33 includes at least the following two parts: the second main body portion 331 and the second branch portion 332.

The second main body portion 331 is a main structure in the second sacrificial layer 33. The orthographic projection of the second main body portion 331 on the cover plate 20 is located at a side of the orthographic projection of the bound portion 13 on the cover plate 20 in the first direction X. In an embodiment, the orthographic projection of the second main body portion 331 on the cover plate 20 is located at the side, close to the first edge E1, of the orthographic projection of the bound portion 13 on the cover plate 20. Further, in the direction parallel to the plane where the cover plate 20 is located, the second main body portion 331 is arranged inside the area defined by the first edge E1, the third edge E3 and the fourth edge E4.

The second branch portion 332 is connected to the second main body portion 331. The second branch portion 332 and the second main body portion 331 may include the same material, or the second branch portion 332 and the second main body portion 331 may include different materials. In an embodiment, the second branch portion 332 and the second main body portion 331 are formed into an integral structure.

The orthographic projection of the second branch portion 332 on the cover plate 20 is located at one or more sides of the orthographic projection of the bound portion 13 on the cover plate 20 in the second direction Y. In an embodiment, one or two second branch portions 332 may be provided. When one second branch portion 332 is provided, the orthographic projection of the second branch portion 332 on the cover plate 20 is located at only one side of the orthographic projection of the bound portion 13 on the cover plate 20 in the second direction Y. When two second branch portions 332 are provided, the orthographic projections of the two second branch portions 332 on the cover plate 20 are located at two sides of the orthographic projection of the bound portion 13 on the cover plate 20 in the second direction Y respectively.

In the embodiments of the present application, to reduce the interfere of the second sacrificial layer 33 with the bound portion 13, the size and structure of the second sacrificial layer 33 are adjusted so that the second sacrificial layer 33 includes both the second main body portion 331 and the second branch portion 332. The orthographic projections of the second main body portion 331 and the second branch portion 332 on the cover plate 20 are respectively located at different sides of the orthographic projection of the bound portion 13 on the cover plate 20 in the first direction X and the second direction Y, thereby reducing the interference between the second sacrificial layer 33 and the bound portion 13 and improving the reliability of the relative position structure between the second sacrificial layer 33 and the bound portion 13.

In some embodiments, reference is made to FIG. 8 and FIG. 9, the first sacrificial layer 32 includes a second sacrificial portion 322, and the second sacrificial portion 322 is arranged at a side of the bound portion 13 facing away from the display portion 11. In the direction parallel to the plane where the cover plate 20 is located, the second sacrificial portion 322 is arranged beyond the bending portion 12.

The second sacrificial portion 322 is located at the side of the bound portion 13 facing away from the display portion 11, and the second sacrificial portion 322 may be arranged to fit against the bound portion 13. The embodiments of the present application do not limit the material composition of the second sacrificial portion 322. In an embodiment, the second sacrificial portion 322 and the first sacrificial portion 321 may include the same material.

In the embodiments of the present application, in the direction parallel to the plane where the cover plate 20 is located, the second sacrificial portion 322 is arranged beyond the bending portion 12. In an embodiment, the second sacrificial portion 322 is arranged beyond the bending portion 12 in the first direction X so that the second sacrificial portion 322 can define the slot-shaped structure C together with the cover plate 20, thereby improving the reliability of the relative position of the sealing glue 40 and reducing the risk of occurrence of issues such as a glue overflow or a glue shortage.

It is to be noted that the second sacrificial portion 322 may be arranged beyond the bound portion 13 and the bending portion 12 in the first direction X. The size of the second sacrificial portion 322 in the second direction Y is not limited in the embodiments of the present application. In an embodiment, the second sacrificial portion 322 may be arranged also beyond the bound portion 13 in the second direction Y.

In addition, according to different practical requirements, the first sacrificial layer 32 may include only the first sacrificial portion 321, or the first sacrificial layer 32 may include only the second sacrificial portion 322, or the first sacrificial layer 32 may include both the first sacrificial portion 321 and the second sacrificial portion 322, which is not limited in the embodiments of the present application.

In some embodiments, as shown in FIG. 8 and FIG. 9, the bound portion 13 includes a body portion 131, a driver chip 132 arranged at a side of the body portion 131 facing away from the display portion 11, and a protection portion 133 arranged at a side of the driver chip 132 facing away from the display portion 11. The orthographic projection of the body portion 131 on the cover plate 20 covers and is beyond the orthographic projection of the protection portion 133 on the cover plate 20. The second sacrificial portion 322 is arranged at a side of the protection portion 133 facing away from the display portion 11, and is arranged at an interval from the body portion 131 in the thickness direction Z.

The bound portion 13 includes at least the body portion 131, the driver chip 132 and the protection portion 133. The driver chip 132 is arranged at the side of the body portion 131 facing away from the display portion 11. The driver chip 132 may include various types, such as a display driver chip 132 and a touch driver chip 132. The display driver chip 132 is configured to implement functions such as image data storage, driving voltage generation, and also image quality improvement through customized algorithms. The touch driver chip 132 mainly implements touch signal processing and is an essential component of a display device with a touch function. Apparently, the display driver chip 132 and the touch driver chip 132 may also be integrated and arranged on the body portion 131.

The protection portion 133 is arranged at the side of the driver chip 132 facing away from the display portion 11, and the protection portion 133 may protect the driver chip 132. Further, the protection portion 133 may be a structure such as an adhesive tape so that the protection portion 133 may be bonded and fixed to the body portion 131, thereby improving the reliability of the relative positions between the driver chip 132 and the body portion 131.

Further, in the embodiments of the present application, the second sacrificial portion 322 is arranged also at the side of the protection portion 133 facing away from the display portion 11 so that the body portion 131 and the second sacrificial portion 322 are arranged spaced apart in the thickness direction Z. In this manner, partial structure in the body portion 131 may not fit against the second sacrificial portion 322, and thus, in the process of glue coating, part of the glue may move to the surface of the body portion 131 at the side facing away from the display portion 11 and be in contact with the body portion 131, that is, the bound portion 13 may also be in contact with the sealing glue 40. In this manner, the reduction in the risk of grease and the like entering the bound portion 13 is facilitated by the sealing glue 40, and thereby improving the usage reliability of the bound portion 13.

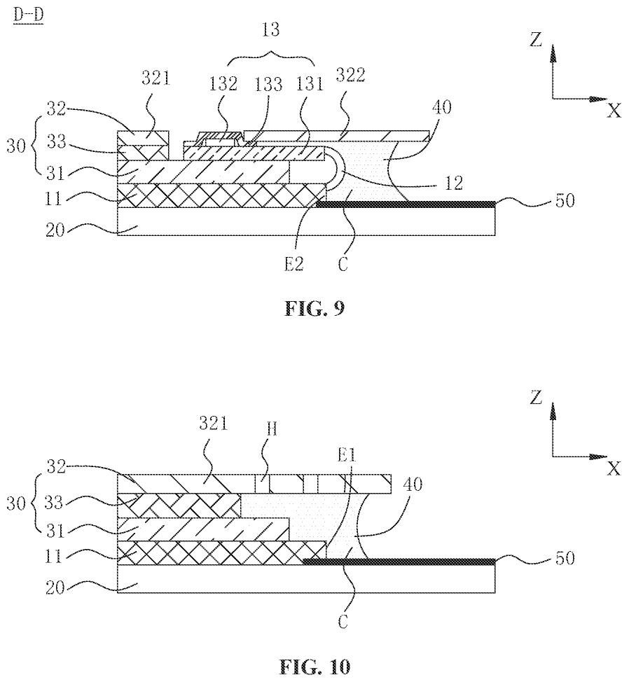

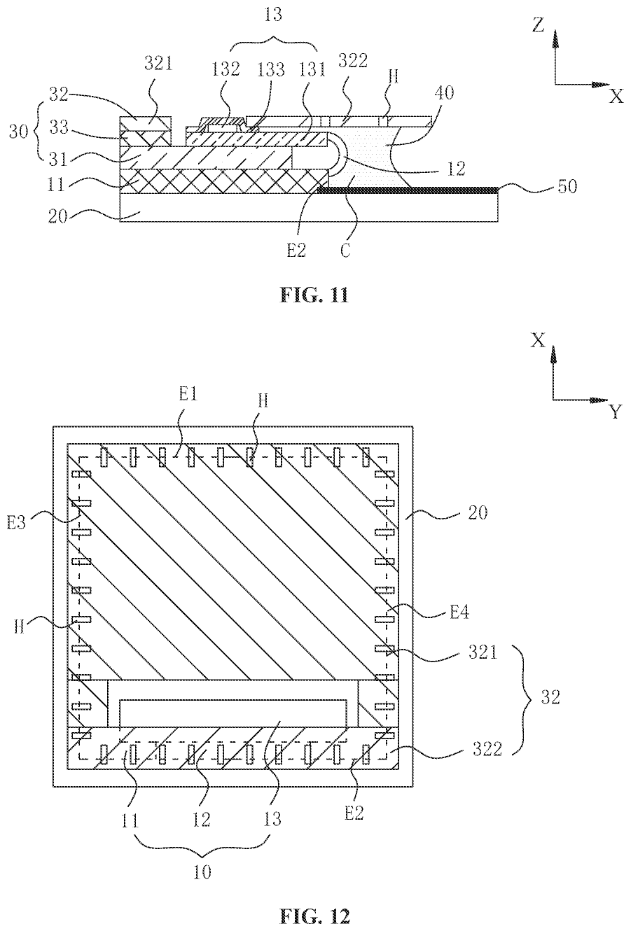

In some embodiments, reference is made to FIG. 10 and FIG. 11, the first sacrificial layer 32 is provided with a through-hole structure H penetrating in the thickness direction Z, and the through-hole structure H is arranged to be in communication with the slot-shaped structure C.

The through-hole structure H penetrates the first sacrificial layer 32 in the thickness direction Z. One or more through-hole structures H may be provided. When the first sacrificial layer 32 includes both the first sacrificial portion 321 and the second sacrificial portion 322, the through-hole structure H may be provided only in the first sacrificial portion 321, or the through-hole structure H may be provided only in the second sacrificial portion 322, or the through-hole structure H may also be located in each of the first sacrificial portion 321 and the second sacrificial portion 322.

The through-hole structure H may have various forms. For example, the through-hole structure H may be a round hole structure, a square hole structure, or a slit structure, etc. The shape and size of the through-hole structure H are not limited in the embodiments of the present application.

In the embodiments of the present application, the through-hole structure H is provided in the first sacrificial layer 32 so that the slot-shaped structure C can be in communication with external environment through the through-hole structure H. Thus, in the process of glue coating, air inside the slot-shaped structure C can be quickly discharged through the through-hole structure H, thereby reducing the risk of occurrence of issues such as a glue overflow.

In some embodiments, reference is made to FIG. 10 to FIG. 12, multiple through-hole structures H are provided, and orthographic projections of the multiple through-hole structures H on the cover plate 20 are arranged at intervals around the periphery of the orthographic projection of the display panel 10 on the cover plate 20.

The multiple through-hole structures H may each be in communication with the slot-shaped structure C to improve the communication performance of the slot-shaped structure C with the external environment. Further, in the embodiments of the present application, the arrangement manner of the multiple through-hole structures H is adjusted so that the orthographic projections of the multiple through-hole structures H on the cover plate 20 are arranged at intervals around the periphery of the orthographic projection of the display panel 10 on the cover plate 20. In this manner, the multiple through-hole structures H can be arranged in a surrounding manner at different positions on the periphery of the display panel 10, and the sealing glue 40 is also generally arranged in a surrounding manner at the periphery of the display panel 10. This design facilitates the reduction in the risk of glue overflow caused by coating the sealing glue 40 at different positions and further improves the coating accuracy of the sealing glue 40, as well as the yield and usage reliability of the subsequently formed display device.

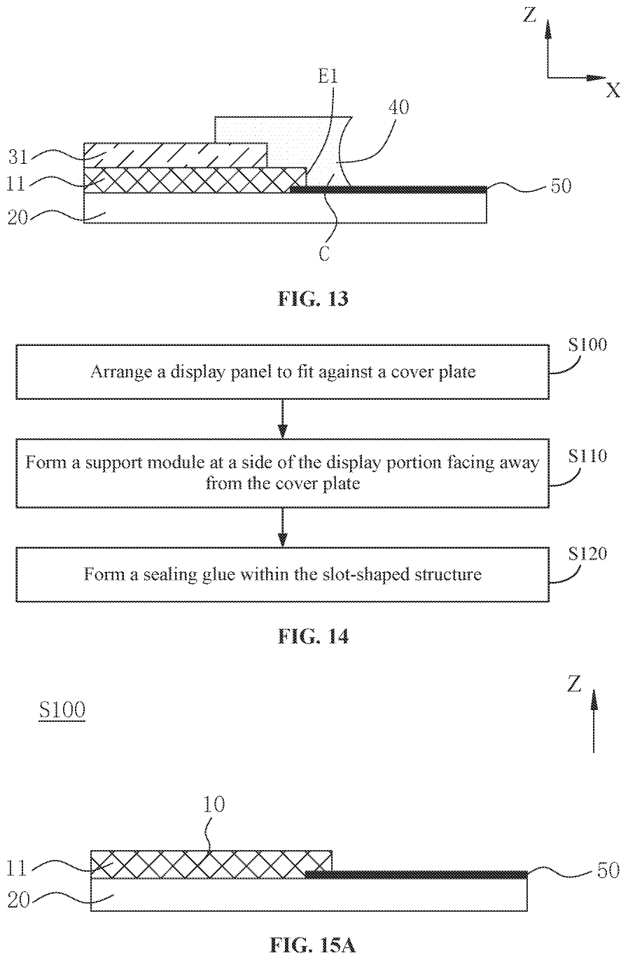

In a second aspect, reference is made to FIG. 13, a display device is provided according to an embodiment of the present application. The display device includes the display panel 10, the cover plate 20, the sealing glue 40 and at least part of structures of the support module in the display module in any of the aforementioned embodiments.

Based on the foregoing content, it can be seen that according to different practical requirements, the display device may include all the structures in the support module 30, or may include only part of the structures in the support module 30. In an embodiment, when the support film layer includes a first sacrificial layer and a second sacrificial layer, in the preparation process of the display device, the first sacrificial layer and the second sacrificial layer may be removed so that the finally-formed display device does not include the first sacrificial layer and the second sacrificial layer. Alternatively, at least one of the first sacrificial layer or the second sacrificial layer may be retained so that the finally-formed display device may include the at least one of the first sacrificial layer or the second sacrificial layer.

It is to be noted that the display device according to the embodiments of the present application has the beneficial effects of the display module in any of the aforementioned embodiments. For details, reference is made to the aforementioned description of the beneficial effects of the display module. Those beneficial effects are not repeated in the embodiments of the present application.

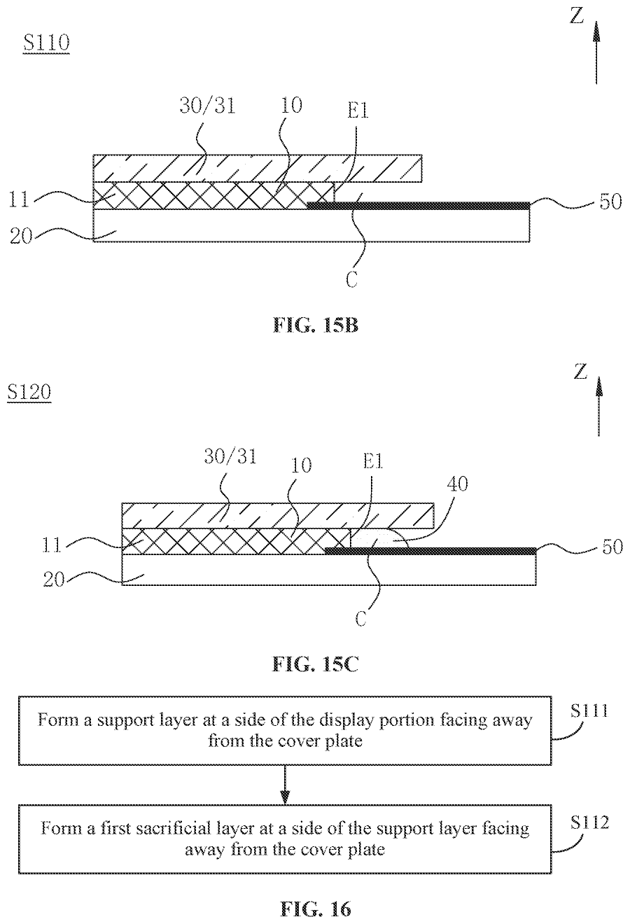

In a third aspect, reference is made to FIG. 14 and FIG. 15, a preparation method of a display device is provided according to an embodiment of the present application, and the preparation method includes S100, S110 and S120.

In S100, the display panel is arranged to fit against the cover plate.

Referring to FIG. 15A, in S100, the display panel 10 includes a display portion 11, the display portion 11 is provided with a light-emitting structure, and the cover plate 20 is arranged at a side of the display portion 11 in the thickness direction Z. The display portion 11 is a functional component for implementing display effects in the display panel 10. The display portion 11 generally includes a variety of different film layers arranged in a stacked manner. For example, the display portion 11 includes an array layer, a light-emitting layer, and an optical adhesive layer, and other layers that are arranged in a stacked manner, and the light-emitting structure can be arranged in the light-emitting layer. In addition to the display portion 11, the display panel 10 may further be provided with other structures depending on requirements. The structures forming the display panel 10 are not limited in the embodiments of the present application.

The cover plate 20 is arranged at the side of the display portion 11 in the thickness direction Z. For example, the cover plate 20 may be arranged at the light-emitting side of the display portion 11 to fit against the display portion 11. The cover plate 20 can protect the display panel 10. In the direction parallel to the plane where the cover plate 20 is located, the cover plate 20 is arranged partially beyond the display panel 10. In an embodiment, an outer contour of the orthographic projection of the display panel 10 on the cover plate 20 may be inside an outer contour of the cover plate 20.

In S110, a support module is formed at a side of the display portion facing away from the cover plate.

Referring to FIG. 15B, in S110, in the direction parallel to the plane where the cover plate 20 is located, the support module 30 and the cover plate 20 are both arranged beyond the display panel 10 to form the slot-shaped structure C. The film layer composition inside the support module 30 is not limited in the embodiments of the present application. For example, the support module 30 may include only one film layer structure, or the support module 30 may include multiple film layer structures stacked in the thickness direction Z.

It is to be noted that, depending on different preparation methods, S100 and S110 may also be interchanged with each other, that is, the support module 30 is formed first, and then the cover plate 20 is formed. This is not limited in the embodiments of the present application.

In S120, a sealing glue is formed in the slot-shaped structure.

Referring to FIG. 15C, in step S120, since the support module 30 and the cover plate 20 are both arranged beyond the display panel 10 in the direction parallel to the plane where the cover plate 20 is located, the support module 30 and the cover plate 20 may together define the slot-shaped structure C. The existence of the slot-shaped structure C can play a certain blocking role for the glue in the process of glue coating so that the formed sealing glue 40 can be limited to the position where the slot-shaped structure C is located and can be maintained at a certain size and in a certain shape, thereby improving the reliability of the relative position of the sealing glue 40 and reducing the risk of occurrence of issues such as a glue overflow or a glue shortage, and further facilitating the improvement of the yield of the display device and improvement of reliability of the display device in blocking sweat stains, grease, etc.

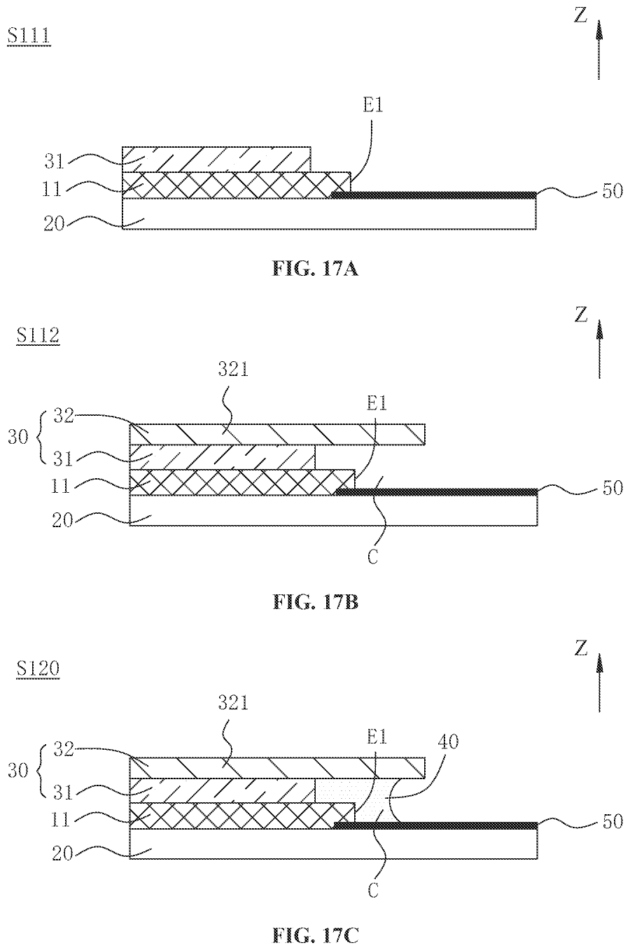

In some embodiments, reference is made to FIG. 16 and FIG. 17, S110 includes S111 and S112.

In S111, a support layer is formed at a side of the display portion facing away from the cover plate.

Referring to FIG. 17A, in step S111, the orthographic projection of the display portion 11 on the cover plate 20 covers the orthographic projection of the support layer 31 on the cover plate 20. The support layer 31 may support and bear the display portion 11 and reduce the risk of excessive deformation of the display portion 11 during subsequent use. In an embodiment, the support layer 31 may include a metal material. For example, the support layer 31 may include a structure with greater structural strength such as a steel sheet.

In S112, a first sacrificial layer 32 is formed at a side of the support layer 31 facing away from the cover plate 20.

Reference is made to FIG. 17B, in S112, the first sacrificial layer 32 is arranged beyond the display panel 10 in the direction parallel to the plane where the cover plate 20 is located to form the slot-shaped structure C. The first sacrificial layer 32 is additionally added in the process of preparation, and thus, the slot-shaped structure C may be formed without interfering with other film layer structures. As shown in FIG. 17C, the existence of the slot-shaped structure C may limit the formation of the sealing glue 40 in the subsequent step S120, thereby improving the reliability of the relative position of the sealing glue 40 and reducing the occurrence of risks such as a glue overflow or a glue shortage.

In some embodiments, in S100, the display panel 10 includes a bending portion connected to the display portion 11. The display portion 11 has a first edge E1 and a second edge in the first direction X which are opposite to each other, and a third edge E3 and a fourth edge E4 in the second direction which are opposite to each other, the second edge is connected to the bending portion, and the first direction X intersects the second direction Y.

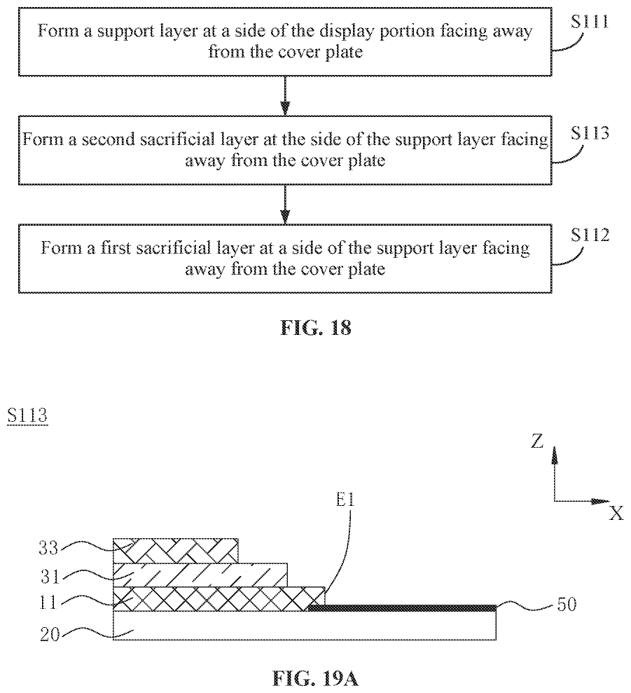

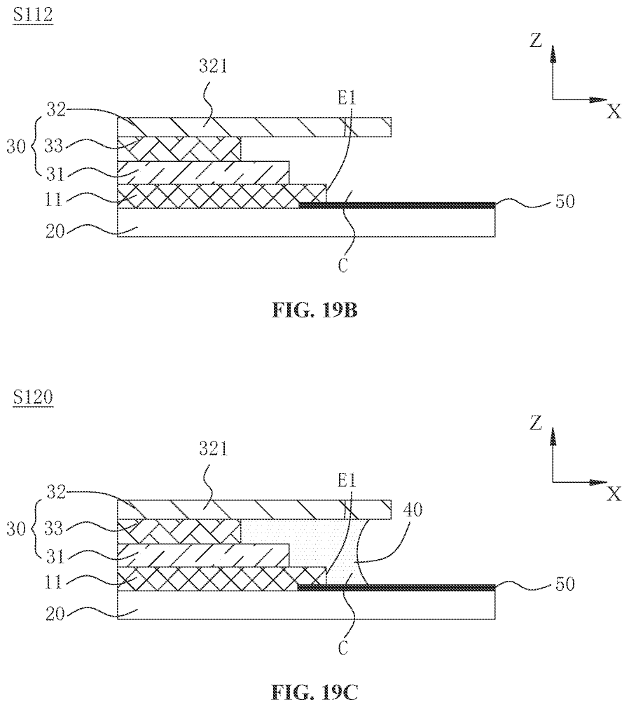

Referring to FIG. 18 and FIG. 19, in step S112, the first sacrificial layer 32 includes a first sacrificial portion 321, and the first sacrificial portion 321 is arranged beyond at least one of the first edge E1, the third edge E3, or the fourth edge E4. Before S112, the method further includes S113. In S113, a second sacrificial layer 33 is formed at the side of the support layer 31 facing away from the cover plate 20.

Referring to FIG. 19A, in step S113, the support layer 31 is arranged beyond the second sacrificial layer 33 in the direction parallel to the plane where the cover plate 20 is located. Referring to FIG. 19B, the second sacrificial layer 33 is arranged to be sandwiched between the first sacrificial portion 321 and the support layer 31. For example, the second sacrificial layer 33 may be arranged to fit against both the first sacrificial layer 32 and the support layer 31. Further, in the direction parallel to the plane where the cover plate 20 is located, the first sacrificial portion 321 and the support layer 31 are both arranged beyond the second sacrificial layer 33, but the support layer 31 is not arranged beyond the display panel 10, so the second sacrificial layer 33 is not arranged beyond the display panel 10, that is, the second sacrificial layer 33 cannot define the slot-shaped structure C together with the cover plate 20.

Further, the support layer 31 is arranged beyond the second sacrificial layer 33 in the direction parallel to the plane where the cover plate 20 is located; therefore, the partial surface of the side of the support layer 31 facing away from the display portion 11 is not covered by the second sacrificial portion 322, and since the support layer 31 and the first sacrificial portion 321 can be spaced apart by the second sacrificial layer 33 in the thickness direction Z, the partial surface of the side of the support layer 31 facing away from the display portion 11 does not fit against the first sacrificial portion 321.

On this basis, reference is made to FIG. 19C, and in the subsequent step S120, part of the glue may move to the surface of the support layer 31 facing away from the display portion 11 and be in contact with the support layer 31, that is, the support layer 31 may be in contact with the sealing glue 40. In this manner, the reduction in the risk of grease and the like entering into the support layer 31 is facilitated by the sealing glue 40, and thereby further improving the reliability of the subsequently formed display device.

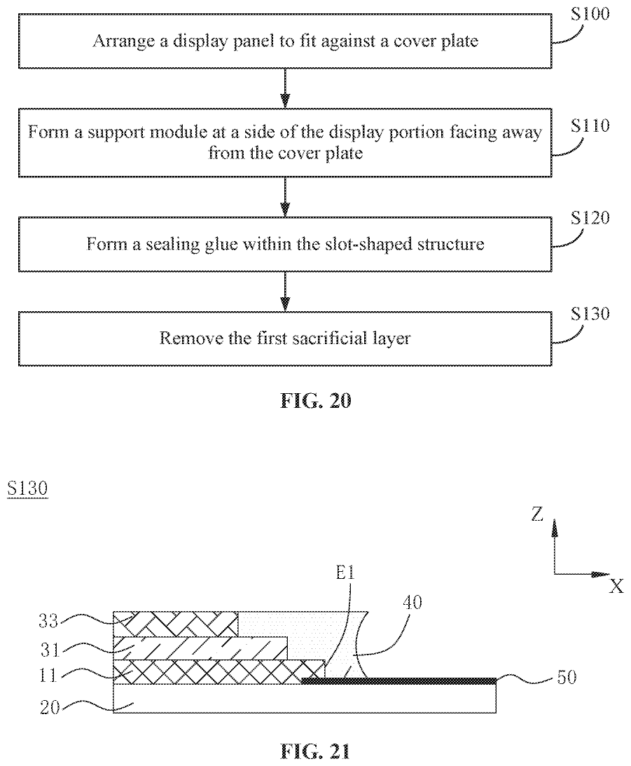

In some embodiments, reference is made to FIG. 20 and FIG. 21, after S120, the method further includes S130.

In S130, the first sacrificial layer is removed.

Referring to FIG. 21, in step S130, the first sacrificial layer 32 may be selectively removed after the sealing glue 40 is fixed in shape so that the first sacrificial layer 32 is not included in the finally-formed display device. This facilitates achieving a thinner and lighter design of the display device.

It is to be noted that when S113 is included in the preparation process of the display device, the second sacrificial layer may also be removed in subsequent steps, or the second sacrificial layer may be retained, which is not limited in the embodiments of the present application.

Although the embodiments disclosed in the present application are as above, the described contents are only intended to facilitate the understanding of the embodiments in the present application rather than being intended to limit the present application. Any skilled person in the technical field to which this application belongs may make any modifications and changes in the form and details of the implementation without departing from the spirit and scope disclosed in the present application. However, the protection scope of the present application is subject to the scope defined by the appended claims.

The above is only embodiments of the present application. The person skilled in the art may clearly understand that for the convenience and simplicity of description, for the replacement of other connection methods described above, reference may be made to the corresponding process in the method embodiments described above, which is not described again here. It is to be understood that the protection scope of the present application is not limited thereto. Any person familiar with the technical field may be ready to think of various equivalent modifications or substitutions within the technical scope disclosed in the present application, and these modifications or substitutions should be covered within the protection scope of this application.

What is claimed is:

1. A display module, comprising:
a display panel, wherein the display panel comprises a display portion, and the display portion is provided with a light-emitting structure;
a cover plate, wherein the cover plate is arranged at a side of the display portion in a thickness direction of the display portion;
a support module, wherein the support module is arranged at a side of the display portion facing away from the cover plate, and in a direction parallel to a plane where the cover plate is located, the support module and the cover plate are arranged beyond the display panel to form a slot-shaped structure; and
a sealing glue, wherein the sealing glue is at least partially located within the slot-shaped structure.

2. The display module according to claim 1, wherein the support module comprises a support layer arranged to fit against the display portion, and in the direction parallel to the plane where the cover plate is located, the support layer is arranged beyond the display portion to form the slot-shaped structure.

3. The display module according to claim 1, wherein the support module comprises a support layer arranged to fit against the display portion, and a first sacrificial layer at a side of the support layer facing away from the display portion, wherein an orthographic projection of the display portion on the cover plate covers an orthographic projection of the support layer on the cover plate; and
in the direction parallel to the plane where the cover plate is located, the first sacrificial layer is arranged beyond the display panel to form the slot-shaped structure.

4. The display module according to claim 3, wherein the display panel comprises a bending portion connected to the display portion and a bound portion connected to the bending portion, wherein the bound portion is bent to the side of the display portion facing away from the cover plate through the bending portion; and
in the direction parallel to the plane where the cover plate is located, the first sacrificial layer is arranged beyond at least one of the display portion or the bending portion.

5. The display module according to claim 4, wherein the display portion comprises a first edge and a second edge in a first direction, and a third edge and a fourth edge in a second direction, wherein the first edge and the second edge are opposite to each other, the third edge and the fourth edge are opposite to each other, the second edge is connected to the bending portion, and the first direction intersects the second direction; and
the first sacrificial layer comprises a first sacrificial portion, and the first sacrificial portion is arranged beyond at least one of the first edge, the third edge or the fourth edge.

6. The display module according to claim 5, wherein an orthographic projection of the bound portion on the cover plate is located outside an orthographic projection of the first sacrificial portion on the cover plate.

7. The display module according to claim 6, wherein the first sacrificial portion comprises a first main body portion and a first branch portion located at a side of the first main body portion in the first direction, an orthographic projection of the first main body portion on the cover plate is located at a side of an orthographic projection of the bound portion on the cover plate in the first direction, and an orthographic projection of the first branch portion on the cover plate is located at at least one side of the orthographic projection of the bound portion on the cover plate in the second direction.

8. The display module according to claim 7, wherein in the direction parallel to the plane where the cover plate is located, the first main body portion is arranged beyond the first edge, the third edge and the fourth edge; and
two first branch portions are provided, orthographic projections of the two first branch portions on the cover plate are arranged at two sides of the orthographic projection of the bound portion on the cover plate respectively, and in the direction parallel to the plane where the cover plate is located, the two first branch portions are arranged beyond the third edge and the fourth edge respectively.

9. The display module according to claim 5, wherein the support module further comprises a second sacrificial layer arranged between the first sacrificial portion and the support layer, and in the direction parallel to the plane where the cover plate is located, the first sacrificial portion and the support layer are arranged beyond the second sacrificial layer.

10. The display module according to claim 9, wherein an orthographic projection of the bound portion on the cover plate is located outside an orthographic projection of the second sacrificial layer on the cover plate.

11. The display module according to claim 10, wherein the second sacrificial layer comprises a second main body portion and a second branch portion located at a side of the second main body portion in the first direction, an orthographic projection of the second main body portion on the cover plate is located at a side of the orthographic projection of the bound portion on the cover plate in the first direction, and an orthographic projection of the second branch portion on the cover plate is located at at least one side of the orthographic projection of the bound portion on the cover plate in the second direction.

12. The display module according to claim 4, wherein the first sacrificial layer comprises a second sacrificial portion, and the second sacrificial portion is arranged at a side of the bound portion facing away from the display portion; and
in the direction parallel to the plane where the cover plate is located, the second sacrificial portion is arranged beyond the bending portion.

13. The display module according to claim 12, wherein the bound portion comprises a body portion, a driver chip arranged at a side of the body portion facing away from the display portion, and a protection portion arranged at a side of the driver chip facing away from the display portion, wherein an orthographic projection of the body portion on the cover plate covers and is beyond an orthographic projection of the protection portion on the cover plate; and
wherein the second sacrificial portion is arranged at a side of the protection portion facing away from the display portion, and the second sacrificial portion and the body portion are spaced apart in the thickness direction.

14. The display module according to claim 3, wherein the first sacrificial layer is provided with a through-hole structure penetrating in the thickness direction of the display portion, and the through-hole structure is arranged to be in communication with the slot-shaped structure.

15. The display module according to claim 14, wherein a plurality of through-hole structures are provided, and orthographic projections of the plurality of through-hole structures on the cover plate are arranged at intervals and around a periphery of an orthographic projection of the display panel on the cover plate.

16. A display device, comprising a display panel, a cover plate, a sealing glue and a support module;
wherein the display panel comprises a display portion, the display portion is provided with a light-emitting structure; the cover plate is arranged at a side of the display portion in a thickness direction of the display portion; the support module is arranged at a side of the display portion facing away from the cover plate, and in a direction parallel to a plane where the cover plate is located, the support module and the cover plate are arranged beyond the display panel to form a slot-shaped structure; and the sealing glue is at least partially located within the slot-shaped structure.

17. A preparation method of a display device, comprising:
arranging a display panel to fit against a cover plate, wherein the display panel comprises a display portion, the display portion is provided with a light-emitting structure, and the cover plate is arranged at a side of the display portion in a thickness direction of the display portion;
forming a support module at a side of the display portion facing away from the cover plate, and forming a slot-shaped structure by arranging the support module and the cover plate to be beyond the display panel in a direction parallel to a plane where the cover plate is located; and
forming a sealing glue within the slot-shaped structure.

18. The preparation method according to claim 17, wherein forming the support module at the side of the display portion facing away from the cover plate comprises:
forming a support layer at the side of the display portion facing away from the cover plate, wherein an orthographic projection of the display portion on the cover plate covers an orthographic projection of the support layer on the cover plate; and
forming a first sacrificial layer at a side of the support layer facing away from the cover plate, wherein in the direction parallel to the plane where the cover plate is located, the first sacrificial layer is arranged beyond the display panel to form the slot-shaped structure.

19. The preparation method according to claim 18, wherein in arranging the display panel to fit against the cover plate, the display panel comprises a bending portion connected to the display portion, the display portion comprises a first edge and a second edge in a first direction, and a third edge and a fourth edge in a second direction, the first edge and the second edge are opposite to each other, the third edge and the fourth edge are opposite to each other, the second edge is connected to the bending portion, and the first direction intersects the second direction; and
in forming the first sacrificial layer at the side of the support layer facing away from the cover plate, the first sacrificial layer comprises a first sacrificial portion, and the first sacrificial portion is arranged beyond at least one of the first edge, the third edge or the fourth edge;
wherein before forming the first sacrificial layer at the side of the support layer facing away from the cover plate, the method further comprises: forming a second sacrificial layer at a side of the support layer facing away from the cover plate, wherein in the direction parallel to the plane where the cover plate is located, the support layer is arranged beyond the second sacrificial layer.

20. The preparation method according to claim 18, wherein after forming the sealing glue within the slot-shaped structure, the method further comprises:
removing the first sacrificial layer.
